(19) United States
(12) Patent Application Publication
(10) Pub. No.: US 2014/0155792 A1
(43) Pub. Date: Jun. 5, 2014

(54) A CARDIO PULMONARY RESUSCITATION DEVICE AND AN INTEGRATED RESUSCITATION SYSTEM THEREOF

(71) Applicants: Jayant Sitaram Karve, Nasik (IN); Balram Bhargava, New Delhi (IN); Sandeep Singh, New Delhi (IN); Praveen Aggrawal, New Delhi (IN)

(72) Inventors: Jayant Sitaram Karve, Nasik (IN); Balram Bhargava, New Delhi (IN); Sandeep Singh, New Delhi (IN); Praveen Aggrawal, New Delhi (IN)

(73) Assignee: ALL INDIA INSTITUTE OF MEDICAL SCIENCES, New Delhi (IN)

(21) Appl. No.: 14/118,044

(22) PCT Filed: May 14, 2012
(86) PCT No.: PCT/IN2012/000348

§ 371 Date: Feb. 13, 2014

(30) Foreign Application Priority Data
May 15, 2011 (IN) 718/DEL/2011
May 15, 2011 (IN) 720/DEL/2011
Feb. 7, 2012 (IN) 351/DEL/2012

(51) Int. Cl. A61H 31/00

(52) U.S. Cl. CPC A61H 31/008
USPC 601/41

(57) ABSTRACT

The present subject matter relates to a cardio pulmonary resuscitation (CPR) device (102) including a backboard (110) to support a subject, and a constriction element (112) to constrict the subject. The constriction element (112) is connected to a decompression element (118). The decompression element (118) is disposed to be placed along the circumference of a thoracic region of the subject and is adapted to adhere to the subject on deployment. Further, a sternum compression unit (120) is attached to the decompression element (118) such that the sternum compression unit (120) is disposed on a side of the decompression element (118). Further, the constriction element (112) is adapted to be constricted and to be slackened for delivering active sternum compression, active circumferential compression, active sternum decompression and active circumferential decompression.

### TECHNICAL FIELD

The present subject matter relates to cardio pulmonary resuscitation (CPR) devices and, in particular, to an integrated resuscitation system including a cardio pulmonary resuscitation (CPR) device.

### BACKGROUND

Sudden cardiac arrest (SCA) is a sudden unexpected failure of heart function. SCA may be understood as an abrupt cessation of pump function of the heart causing inadequate cerebral and cardiac perfusion. SCA is one of the leading causes of death in both developed as well as developing countries. For the world, the estimated annual burden of SCA is 4-5 million cases; and more than 0.4 million Americans and 0.7 million Europeans are victim of SCA each year. In India, SCA accounts for more than 40-45% of cardiovascular deaths annually. The situation in developing countries is dismal as less than 1% people survive after SCA, as against 5% in the developed countries. Usually, SCA is reversible if a patient is administered cardiopulmonary resuscitation (CPR) on time and is provided with appropriate emergency care. CPR is a well known and valuable method of first aid in case of SCA. CPR is usually employed to resuscitate patients who have suffered from SCA after a heart attack, electric shock, chest injury, or due to other cause. It has been widely known that effective CPR can save SCA victims, especially when applied immediately after SCA.

Based on extensive review of clinical and laboratory evidence, the American Heart Association (AHA) has published updated guidelines for CPR and Emergency Cardiovascular Care in 2010, according to which a chest compression rate is required to be at least 100 per minute and a compression depth for adults is required to be at least 2 inches while administering CPR. Accordingly, effective, consistent, and un-interrupted chest compression during CPR is designated as the primary intervention technique for management of SCA. As a result, manually administering CPR to a victim is a task that requires well-trained personnel for carrying out the procedure.

Typically, CPR is administered through various manually operated apparatus and devices. However, there are several problems associated with the manually operated CPR devices, including fatigue to an operator, variation in the rate, force and duration of compressions, and limited facility for transportation and movement of the patient while manual CPR is being carried out. Further, inexperienced operators can often cause injuries to the patient, such as fractures to the ribs and sternum, lung damage or laceration to the liver.

A number of automated CPR devices have been developed with a view to overcoming the problems of the conventional manual CPR devices. The automated CPR devices apply compression force through a pad placed over an anterior surface of the patient's chest via motorized belts. However, the automated CPR devices also have a number of deficiencies. For example, there may be a tendency for a sternum compressor of the automated CPR device to shift position on the sternum, which may lead to greater instances of rib and sternum fractures. Further, the automated CPR devices may lead to bulging of the unconstrained lateral chest surfaces and loss of compression.

Further, certain other automated CPR devices include an automated inflatable cuff that surrounds the anterior and lateral surfaces of the chest for uniform circumferential compression. This in turn results in less rib compression required for a given volume or intra-thoracic pressure change. However, the inflatable cuff requires a large size (volume) bladder surrounding the chest and requires rapid inflation and deflation of the bladder, up to 100 times a minute. In order to achieve such high rates of inflation and deflation, such CPR devices require a cumbersome pneumatic system, which is impractical for portable emergency use.

Additionally, as per the 2010 AHA Guidelines, successful resuscitation following a cardiac arrest requires an integrated set of coordinated actions including—(1) Early access; (2) Early CPR; (3) Rapid defibrillation; (4) Effective advanced life support; and (5) Integrated post-cardiac care. As per the updated guidelines of AHA 2010, an operator may begin CPR immediately and provide shock delivery via defibrillator, if available. A subject's chances of survival would decrease with increase in time interval between compressions and defibrillation. Thus, methods for effective CPR and defibrillation would be important for increasing the survival chances of the subject.

### SUMMARY

This summary is provided to introduce concepts related to a cardio pulmonary resuscitation (CPR) device and the concepts are further described below in the detailed description. This summary is neither intended to identify essential features of the claimed subject matter nor is it intended for use in determining or limiting the scope of the claimed subject matter.

In an embodiment, the subject matter disclosed herein describes a cardio pulmonary resuscitation (CPR) device. The CPR device includes a backboard to support a subject in a supine position. A constriction element is operationally coupled to the backboard, where one end of the constriction element is drawn out from one end of the backboard to constrict the subject. The constriction element is connected to a decompression element such that the decompression element faces the backboard and is disposed along the circumference of a thoracic region of the subject on deployment. Further, the decompression element is adapted to adhere to the subject on deployment. To the decompression element, a sternum compression unit is attached in such a way that the sternum compression unit is over a sternum region of the subject on deployment. The sternum compression unit is adapted to compress the subject on deployment. In accordance with the present subject matter, the constriction element is adapted to be constricted for compressing the sternum compression unit and the decompression element to deliver active sternum compression and active circumferential compression, and the constriction element is adapted to be slackened and pull back the sternum compression unit and the decompression element to deliver active sternum decompression and active circumferential decompression.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the drawings to reference like features and components:

FIG. 1a illustrates an integrated resuscitation system having a cardio pulmonary resuscitation (CPR) device, in accordance with an embodiment of the present subject matter.

FIG. 1b illustrates electrocardiogram (ECG) pads disposed on the CPR device, in accordance with an embodiment of the present subject matter.

FIGS. 1c and 1d illustrate implementations of a defibrillator pad on the CPR device, in accordance with an embodiment of the present subject matter.

FIG. 1e illustrates the ECG pad and the defibrillator pad on the CPR device, in accordance with an embodiment of the present subject matter.

FIG. 1f illustrates an implementation of multipurpose pads simultaneously functioning as the ECG pad and the defibrillator pad, in accordance with an embodiment of the present subject matter.

FIGS. 2a to 2c illustrate singular continuous structured constriction element with plurality of decompression elements and a sternum compression unit, in accordance with an embodiment of the present subject matter.

FIGS. 3a to 3d illustrate variants of decompression elements mounted on the singular structured constriction element, in accordance with an embodiment of the present subject matter.

FIGS. 4a to 4c illustrate the singular structured constriction element having a decompression element, in accordance with an embodiment of the present subject matter.

FIGS. 4d and 4e illustrate sternum compression unit embodied as a central inflatable chamber, in accordance with an embodiment of the present subject matter.

FIGS. 5a to 5d illustrate deployment of a backboard of a cardio pulmonary resuscitation (CPR) device, in accordance with an embodiment of the present subject matter.

FIGS. 6a to 6c illustrate telescopic deployment of a frame of the CPR device, in accordance with an embodiment of the present subject matter.

FIG. 6d illustrates a perspective view of the frame of the CPR device, in accordance with an embodiment of the present subject matter.

FIG. 7a illustrates a first embodiment of the frame of the CPR device, in accordance with the present subject matter.

FIG. 7b illustrates a second embodiment of the frame of the CPR device, in accordance with the present subject matter.

FIGS. 8a to 8c illustrate deployment of a constriction element of the CPR device, in accordance with an embodiment of the present subject matter.

FIGS. 9 and 10 illustrate two different perspective views of the CPR device, in accordance with an embodiment of the present subject matter.

FIGS. 11a to 11f illustrate different variants of link elements attached to a constriction element, in accordance with an embodiment of the present subject matter.

FIG. 12 illustrates different perspective views of the CPR device, in accordance with an embodiment of the present subject matter.

FIG. 13 illustrates an input-and-display unit of the CPR device, in accordance with an embodiment of the present subject matter.

### DETAILED DESCRIPTION

The subject matter disclosed herein describes a CPR device and an integrated resuscitation system including the CPR device adapted in accordance with present subject matter. The integrated resuscitation system may further include a defibrillation unit, a real-time monitoring-and-feedback unit for monitoring medical parameters of a subject, and a global positioning system (GPS) for tracking a location of the CPR device. The integrated resuscitation system can deliver effective sternum and circumferential compression and decompression, defibrillation and provide real-time monitoring. The integrated resuscitation system is easy to use, portable and cost effective, making it suitable for use even in remote or rural areas.

The cardio pulmonary resuscitation (CPR) device in the integrated resuscitation system can be implemented for administrating CPR to sudden cardiac arrest (SCA) subjects. The CPR device described herein is adapted to deliver a combination of active sternum compression, active sternum decompression, active circumferential compression, and active circumferential decompression.

The administration of CPR is primarily based on chest compression. A typical human rib cage encloses a thoracic cavity, which contains lungs and a heart. There are 12 ribs that constitute the human rib cage. A maximum pressure at the time of CPR is exerted on upper ribs that are attached in a head of the sternum cavity. Due to their elasticity, the upper ribs allow movement during inhaling and exhaling the air. The expansion of the rib cage produces an increase in volume and a resulting partial vacuum, or negative pressure, in the thoracic cavity.

The chest compression can be divided into two basic mechanisms, a cardiac pump mechanism and a thoracic pump mechanism. In the cardiac pump mechanism, an external chest compression is used to squeeze heart chambers between sternum and cardiac vertebra of a subject. While the cardiac pump mechanism is known to be effective; however, its operation requires good mechanical coupling between the sternum and the heart. This is generally found in children who have a compliant chest wall; however, in most adults this coupling is indirect, resulting in the predominant use of thoracic pump mechanism for CPR. As per the thoracic pump mechanism, the chest compression causes a global rise in an intra-thoracic pressure sufficient to force blood from the pulmonary vasculature, through the heart, into the periphery. In said condition, the left portion of the heart merely acts as a conduit. The collective pulmonary vasculature performs the function of the main pumping chamber of the heart. In the thoracic pump mechanism, because of the tendency towards equalization of aortic and venous pressures during compressions, forward flow tends to be less than that with the cardiac pump mechanism.

The passive recoil of a subject's chest wall during decompression generates negative intrathoracic pressures resulting in venous return to heart as well as retrograde perfusion of coronary circulation by reversal of blood flow from descending to ascending aorta. Coronary blood flow predominantly occurs during decompressions rather than compressions.

Active decompression leads to creation of more negative pressure or vacuum which helps augmenting the venous return as well as better coronary perfusion. This may prime the heart for a more effective subsequent compression.

These mechanisms (cardiac pump and thoracic pump) are not mutually exclusive and may coexist during different phases of prolonged resuscitation in varying proportions (Hybrid pump mechanism). The dominant mechanism may even vary at different times during a single compression cycle. For example, the effective cardiac compression occurs only at or near the point of maximal chest compression. In an example, the integrated resuscitation system of the present subject matter also has a Hybrid Pump Mechanism. As per the present subject matter, the device is able to deliver circumferential chest compression (thoracic pump mechanism) and additionally sternal compression (cardiac pump mechanism) during a compression cycle to further augment the cardiac output.

According to an embodiment of the present subject matter, a CPR device is adapted to perform active sternum compression, active sternum decompression, active circumferential compression, and active circumferential decompression for resuscitation of a subject. The active circumferential compression exerts uniform force on antero-lateral chest wall mimicking the thoracic pump mechanism by causing blood to flow from pulmonary vasculature into systemic circulation, while the heart merely acts as a conduit. The active circumferential as well as the active sternum compression may minimize the complications arising due to the trauma inherent to single point chest compression. During the active decompression phase, the active circumferential and sternal decompression may generate more negative intra-thoracic pressure resulting in enhanced venous return as well as retrograde coronary perfusion.

The active decompression phase substantially improves haemodynamics during delivering the CPR by generating negative intrathoracic pressure, resulting in enhanced venous return, hence drawing blood back into the heart and preloading the heart with blood prior to commencement of the next cycle. Also, due to higher negative intrathoracic pressure, there is better retrograde perfusion of the coronary arteries. This enhances the cardiac muscle performance and subsequent higher cardiac output and better vital organ perfusion.

The subject matter disclosed herein is described with reference to the figures in the description hereinafter.

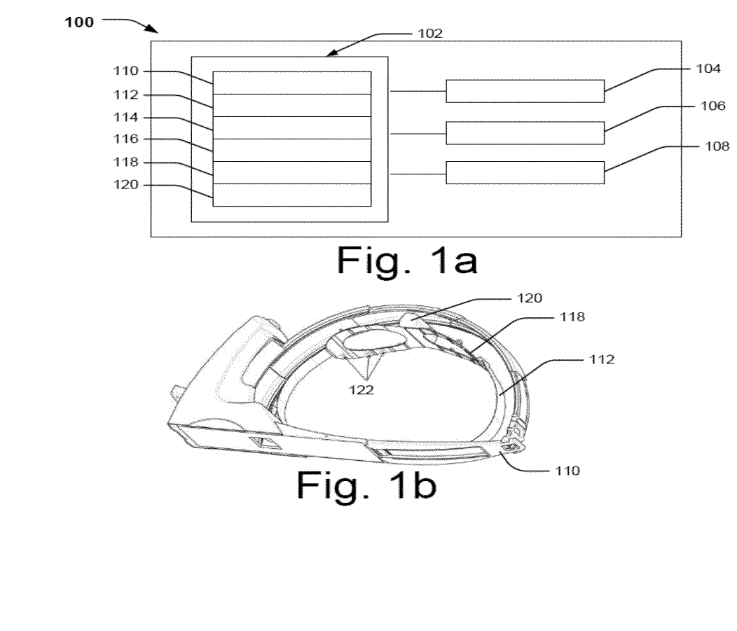

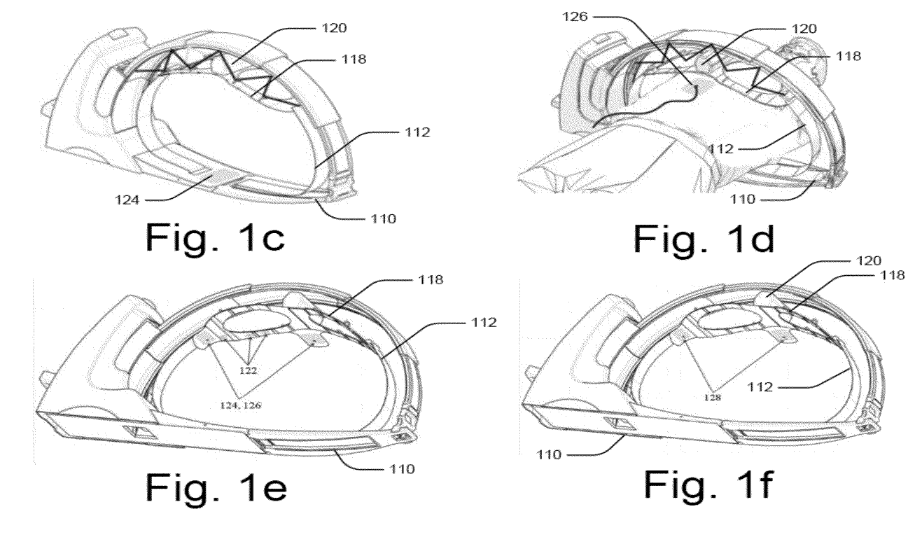

FIG. 1a shows a block diagram of an integrated resuscitation system 100 including a CPR device 102. In an embodiment, the CPR device 102 includes a backboard 110 to support a subject in a supine position. The backboard 110 functions as a base against which a subject's back would rest. The backboard 110 can have a curvature in a way that a subject automatically gets centred along an axis of the backboard 110. The backboard 110 may have visual markings, which guide a CPR operator for positioning of the subject. The visual markings on the backboard 110 help a CPR operator to centre the subject on the CPR device 102. The visual markings can glow in dark, and are useful even in situation where there is insufficient ambient light. Further, the backboard 110 can be a single piece structure or multi-segment structure. Also, the backboard 110 can be provided in a folded or a collapsible implementation. In an example, multiple segments of the backboard 110 connected together can either be hinged or telescopically connected together.

In an implementation, the CPR device 102 further includes a constriction element 112 operationally coupled to the backboard 110. The constriction element 112 may be a singular continuous structure or may be composed of multiple segments. In one implementation, the constriction element 112 may be a strap or a belt like structure that can be easily manipulated and snugly fitted around the chest of a subject. On deployment, in one embodiment, one end of the constriction element 112 can be drawn out from one end of the backboard 110 and around a subject to constrict the subject. The constriction of the constriction element 112 may be achieved either by manual or automated means, such as a powerdrive or a manual power input, or by just strapping the constriction element 112 around a circumference of a thoracic region of the subject.

In one implementation, the constriction element 112 is mounted or spooled on spools or rollers 114, driven by a drive mechanism 116. The drive mechanism 116 can drive the rollers 114 bi-directionally, through a clutch, gear and brake arrangement (not shown in figures), to constrict and slacken the constrict element around a sternum region of a subject.

The constriction element 112 is further connected to a decompression element 118. The decompression element 118 may be a single element or may be composed of multiple decompression interfaces. In one example, the decompression element 118 may be integrated with the constriction element 112. In another example, the decompression element 118 may be connected to the constriction element 112 at one or more points.

In one implementation, as shown in FIGS. 1b to 1c, the decompression element 118 is a single element integrated with the constriction element 112 so that the decompression element 118 is in contact with a thoracic region of a subject upon deployment. The decompression element 118 is spread across the entire chest and side areas to deliver active circumferential decompression on deployment. Further, the decompression element 118 is adapted to adhere, i.e., hold on, to the body of a subject for performing active decompression. It will be understood that the decompression element 118 can adhere to the body of the subject by any means known in the art, such as suction pressure, adhesives, gels, etc.

In an implementation, as shown in FIGS. 1b to 1c, a sternum compression unit 120 is attached to the decompression element 118 such that the sternum compression unit 120 is disposed on a side of the decompression element 118 facing away from the backboard 110. In other implementations, the sternum compression unit 120 may be attached to the decompression element 118 such that the sternum compression unit 120 faces towards the backboard 110. Further, the sternum compression unit 120 can also be adapted to adhere to the body of the subject using any means known in the art. The sternum compression unit 120 is disposed in a sternum region of a subject and is adapted to compress the sternum of the subject upon deployment.

In an embodiment, to provide CPR, the drive mechanism 116 can be used to drive the spools or the rollers 114 to constrict the constriction element 112 around a subject's chest upon complete deployment of the CPR device 102. The constriction element 112 is adapted to achieve constriction for compressing the sternum compression unit 120 and the decompression element 118 to deliver active circumferential compression and active sternal compression. After completion of compression cycle, the drive mechanism 116 reverses the direction of rotation of the rollers 114 to slacken or loosen the constriction element 112. During slackening, the constriction element 112 is adapted to be slackened and pull back the sternum compression unit 120 and the decompression element 118 to deliver active sternum decompression and active circumferential decompression.

The integrated resuscitation system 100 further includes a real-time monitoring-and-feedback unit 104 coupled to the CPR device 102, a defibrillator unit 106 connected to the CPR device 102, and a global positioning system (GPS) 108 integrated with the CPR device 102.

In an implementation, the real-time monitoring-and-feedback unit 104 includes electrodes attached to at least one of the backboard 110 and the constriction element 112 for monitoring medical parameters of the subject, and includes an output unit to provide the medical parameters as an output. In an implementation, as shown in FIG. 1b, the real-time monitoring-and-feedback unit 104 may be provided with electrocardiogram (ECG) pads 122 to determine ECG of a subject during CPR. The ECG pads 122 are disposed on the decompression element 118 such that the ECG pads 122 face the backboard 110. The real-time monitoring-and-feedback unit 104 may also be provided with inbuilt memory to store the data about relevant parameters, such as compression rate, compression depth, ECG, time, heart rate, etc., for a subject. The data stored in the inbuilt memory can also be downloadable on external hard drives for future references by the subject. Thereby, the real-time monitoring-and-feedback unit 104 can also allow a CPR operator to communicate with a central facility for additional help or input.

In an implementation, the global positioning system 108 of the integrated resuscitation system 100 is used to track a subject's location, for example, while being administered CPR using the integrated resuscitation system 100, in real time so that the same may be communicated in case an alarm is to be sounded.

In an implementation, the defibrillator unit 106 includes defibrillator pad 124, as shown in FIGS. 1c to 1f, positioned on the backboard 110, so that the defibrillator pad 124 automatically gets connected to the CPR device 102 during CPR. The defibrillator pad 124 is mounted on the backboard 110 in such a way that the defibrillator pad 124 is electrically isolated from the CPR device 102 and does not interfere with the CPR device 102, and additionally, does not harm operators of the CPR device 102. In another implementation, the defibrillation unit 106 may include a defibrillator pad that is integrated within the CPR device 102 or can be provided as a separate defibrillator pad that can be connected to the CPR device 102 via a wired or wireless system, for performing defibrillation.

In case the defibrillator unit 106 is affixed to the CPR device 102, a second defibrillator pad 126 linked with an electric wired connection is placed on a sternum region of a subject, as shown in FIG. 1d. Further, the second defibrillator pad 126 is placed just lower to the decompression element 118, so the second defibrillator pad 126 is not spoiled or loses contact during compressions.

In one embodiment, the ECG pads 122 and the defibrillator pads 124, 126 are used to perform ECG and defibrillation individually, as represented in FIG. 1e. As can be seen from FIG. 1e, the ECG pads 122 and the defibrillator pads 124, 126 can be disposed on a side of the decompression element 118 facing the backboard 110 or subject.

In another alternative embodiment, multifunctional pads 128 adapted to perform ECG and defibrillation, are used instead of the ECG pads 122 and the defibrillator pads 126. The multifunctional pads 128 are disposed on a side of the decompression element 118 facing the backboard 110 or subject, as can be seen from FIG. 1f.

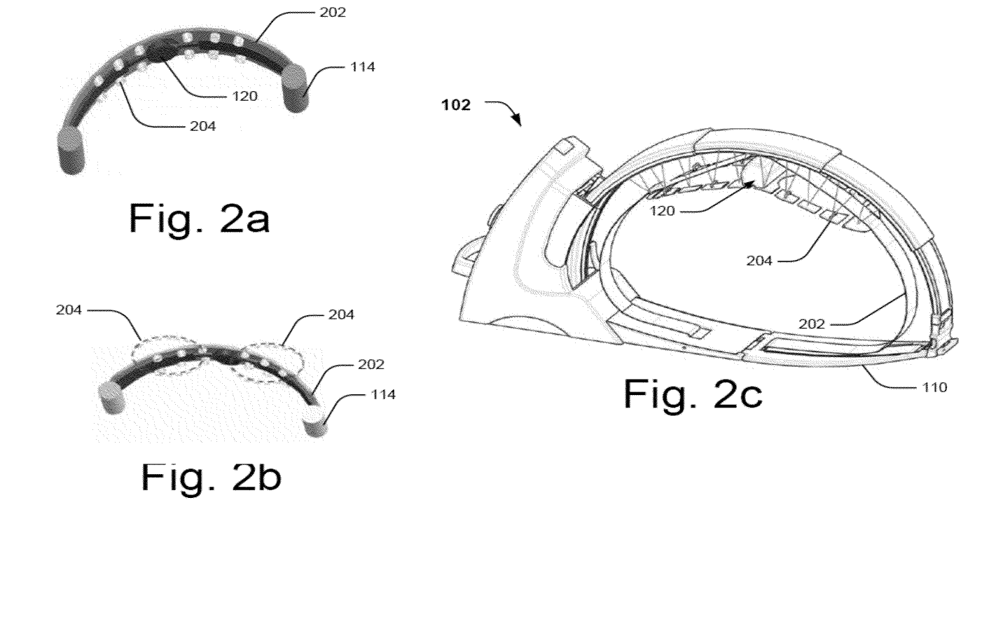

FIGS. 2a to 2c illustrate other embodiments of the CPR device 102, where a singular continuous structured constriction element 202 can be used in accordance with the present subject matter. FIG. 2a shows a perspective view of singular continuous structured constriction element 202 connected to the rollers 114. On the inner surface of the constriction element 202, the decompression element 118 composed of a plurality of decompression elements 204 can be disposed, as shown in FIGS. 2a to 2c.

Further, in an implementation, as represented in FIGS. 2a and 2b, the sternum compression unit 120 is disposed on the constriction element 202 in a sternum region of a subject such that the sternum compression unit 120 faces the backboard 110 or a subject. In alternative implementation represented in FIG. 2c, the sternum compression unit 120 is disposed between the constriction element 202 and the string of plurality of decompression elements 204.

By the usage of the plurality of decompression elements 204, the active circumferential decompression is carried out along the circumference of the thoracic region. Such a configuration accommodates the geometrical variations at local anatomical locations and allows for effective active decompression even in case of non-adhesion of a few of the decompression elements 204. The resultant decompression achieved is much stronger because of distributed decompression mechanism along the chest wall. This in turn results in minimization of local concentrated force and pulling of the chest wall in outward direction along the circumference.

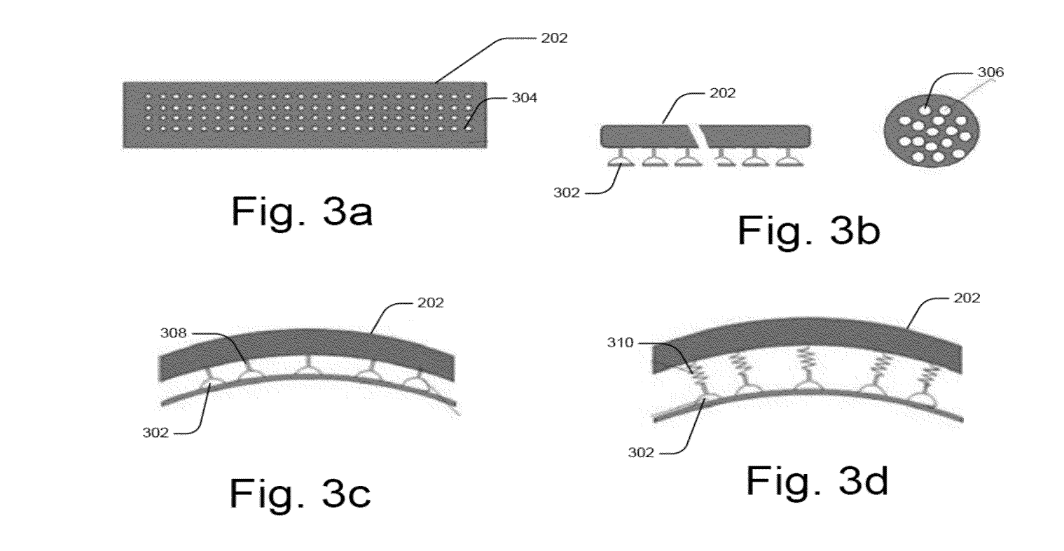

In another embodiment represented in FIG. 3a, the decompression element 118 is disposed along the circumference of the thoracic region of a subject on an inner side of the singular contiguous structured constriction element 202.

In various implementations as shown in FIGS. 3a to 3b, the decompression element 118 can include one or more of a string of vacuum cups 302, a pneumatic pad, a micropore 304 with vacuum, and an adhesive patch 306 for adhering to the subject.

Further, in an implementation as shown in FIGS. 3c and 3d, the decompression element 118 may include a string of suction or vacuum cups 302 mounted on inner surface of the constriction element 202. The string of vacuum cups 302 are connected to the constriction element 202 with either a rigid link 308 (FIG. 3c) or flexible link 310 (FIG. 3d). When the constriction element 202 is constricted on a subject's chest, the air inside the vacuum cup 302 is expelled out. Thereby, the periphery of the vacuum cup 302 creates a sealed joint with the skin surface of a subject. This results in an adhesion of the vacuum cup 302 on the chest wall of the subject, which supports active recoil of the chest during the decompression cycle.

In yet another implementation, the decompression element 118 may include an adhesion layer on an inner surface. The adhesion layer can be an integral part of the decompression element 118 or the adhesion layer can be detachably disposed on the decompression element 118. During a decompression cycle, the decompression element 118 may pull the subject chest or thorax circumferentially outward with the help of adhesion layer.

In an example, a thin protective film (not shown in figures) is provided over the adhesion layer of the decompression element 118 in order to avoid any undue adhesion and to maintain the adhesiveness of the adhesion layer till the deployment. The thin protective film can be pulled out prior to the deployment of the decompression element 118 on the chest of a subject.

Thus, the decompression element 118 can adhere to the body of the subject using any means known in the art and can achieve recoil management. During operation of the CPR device 102, when the constriction element 202 is slackened during a decompression cycle, the decompression element 118 pulls the chest outwardly imparting active recoil to the chest. The amount of active recoil may be controlled electronically through microcontroller based electronic means or manual mechanisms. Thus, the pulling action exerts outward force on the chest wall and creates negative intrathoracic pressure. This facilitates retrograde flow of blood and coronary artery perfusion.

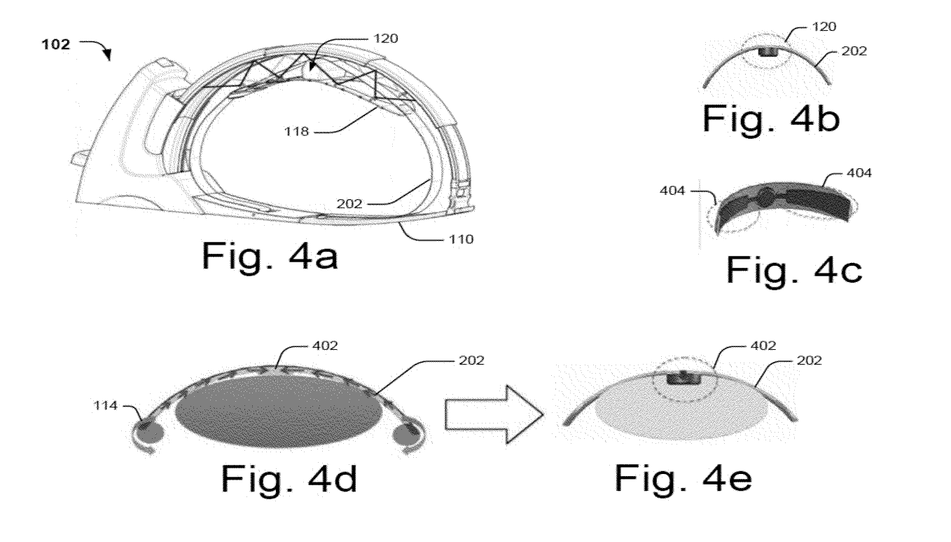

FIGS. 4a to 4c, represent various embodiments of the sternum compression unit 120. In one embodiment, the sternum compression unit 120 is provided in the form of a central member, such as a solid block, in the sternum region on the inner side of the constriction element 202. The central member 120 can be adapted to substantially resemble the heel of a hand positioned near the heart, i.e., at the sternum. The central member 120 can have greater thickness than the rest of the constriction element 202 and adapted to easily deliver compressions to the sternum region, for example, to the heart, as desired. The central member 120 may be connected with collapsible conduits 404 via which the central member 120 can be activated electromechanically, pneumatically, or hydraulically. During operation of the CPR device 102, the central member 120 is capable of delivering compressions in sync or out of sync with circumferential compression helping to squeeze out the blood from heart, by utilizing heart pump mechanism of chest compression. Alternatively, during operation, the central member 120 can create squirts towards the end of the circumferential compression.

In another implementation as represented in FIGS. 4d and 4e, the sternum compression unit 120 may be provided as a central inflatable chamber or bellow 402 that is adapted to expand and contract rhythmically. The central inflatable chamber or bellow 402 exerts a combination of circumferential and central (sternum) compressive forces when placed on the chest of a subject. As an example, a variant of the CPR device 102 may include a constriction element provided with a passageway for accommodating liquid or gas on its inner side. The liquid or gas runs through the passageway, as shown by means of arrows in FIG. 4d, such that upon actuation, the liquid or gas may enter the central inflatable chamber 402 causing it to expand to a predetermined extent, as shown in FIG. 4d, and deliver a compressive force/impulse to the sternum, during deployment. With the delivery of the mentioned compressive force, blood is ejected out of the heart. Further, upon actuation, the central inflatable chamber 302 is contracted to return to its original shape, by withdrawing the liquid or gas. In an implementation, the withdrawal of the fluid can be controlled, so that the contraction of the central inflatable chamber is slow, allowing venous blood to slowly enter the heart. Thus, the heart muscles can receive a slow massage, and with repeated reiterations of the above, resuscitation of the subject occurs.

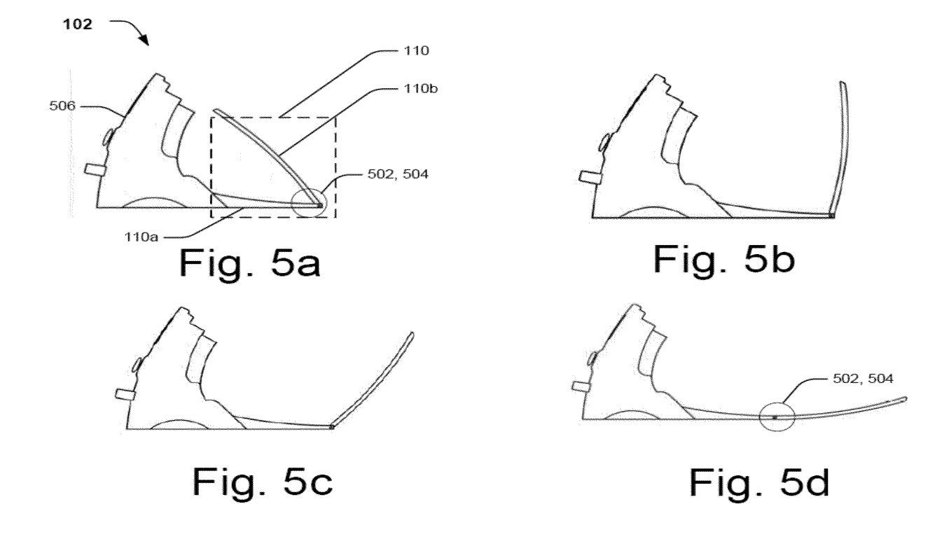

FIGS. 5 to 8 illustrate the deployment and operation of the CPR device 102 for administering CPR to a subject suffering from SCA, and for other related operations of the integrated resuscitation system 100, in accordance with the present subject matter. For simplicity, the decompression element 118 and the sternum compression unit 120 have not been shown in FIGS. 5 to 8. However, it will be understood that the CPR device 102 will include the decompression element 118 and the sternum compression unit 120 as per any of the various embodiments discussed earlier.

For deploying the CPR device 102 to administer CPR to the subject, the backboard 110 may be telescopically deployed in a manner shown in FIGS. 5a to 5d in accordance with an embodiment of the present subject matter. FIG. 5a illustrates the backboard 110 in a substantially closed condition, and FIG. 5b and FIG. 5c illustrate the manner in which the backboard 110 may be opened. Finally, FIG. 5d illustrates the backboard 110 in completely open condition, i.e., in completely deployed condition.

In the embodiment represented in FIGS. 5a to 5d, the backboard 110 is formed of two segments 110a and 110b connected together by a hinge 504. In an embodiment, at one end, a first segment 110a of the backboard 110 is integrated with a console 506 of the CPR device 102 and at another end; a second segment 110b of the backboard 110 has provisions for locking or unlocking the backboard 110 within the console 506. Thus, in a locked position, the second segment 110b is locked within the console 506.

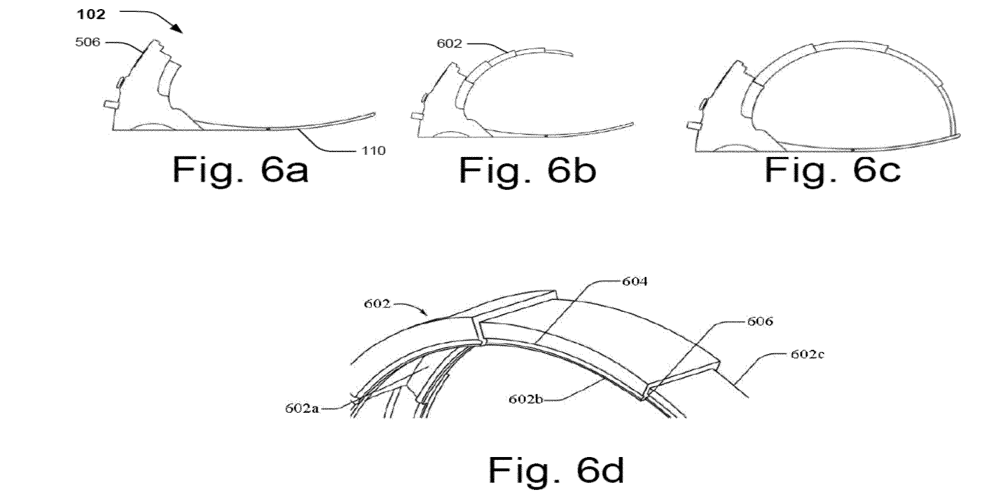

In an example, an actuation switch 502 is integrated within the backboard 110 in the region of the hinge 504. In an implementation, when the backboard 110 is completely deployed, as shown in FIG. 5d, the actuation switch 502 gets automatically activated and reboots an operating system of the CPR device 102. The automatic activation saves valuable time and does not require attention or intervention by an operator for rebooting in an otherwise emergency situation such as resuscitation. Thus, the CPR device 102 automatically becomes ready for use after booting of the operating system. In another implementation, the actuation switch 502 can be located on a console 506 of the CPR device 102 and can be activated when a rigid frame (shown in FIGS. 6A to 6D) is being deployed from the console 506.

Further, the backboard 110 of the CPR device 102 can be deployed in a number of ways. In an example, the backboard 110 can be pushed under a subject and the subject's torso is positioned on the backboard 110. In another example, the subject is rolled on one side and the backboard 110 is slid below the subject. Subsequently, the subject is rolled back to be positioned on the backboard 110 of the CPR device 102. The said deployments enables a single-operator operation of the CPR device 102, and saves valuable time and effort as subject lifting is not required during the deployment of the backboard 110. In yet another example, the subject can be lifted and the backboard 110 is kept below the subject, and the subject is then rested on the backboard 110. Further, in one implementation, the backboard 110 may also be provided with handles (not shown in figures). The handles may be useful while the transportation and/or deployment of the CPR device 102.

Once the backboard is completely deployed, a rigid frame 602 of the CPR device 102 is drawn out from the console 506 in a telescopic manner, as shown in FIGS. 6a to 6d. The rigid frame 602 is drawn out either manually or automatically by manual or electronic means. The rigid frame 602 along with the console 506 and the backboard 110 form a rigid structure to support the subject, to house all other components of the CPR device 102, and to provide interface with external devices or inputs.

In one embodiment, the rigid frame 602 can be deployed in a telescopic manner. In the said embodiment, the rigid frame 602 rests inside the console 506 prior to its deployment, as can be seen from FIG. 6a. Upon requirement of the CPR device 102, the deployment of the rigid frame 602 is carried out in a telescopic manner shown in FIGS. 6a to 6c. As can be seen, the rigid frame 602 is pulled out of the console 506 for deployment, and the rigid frame 602 extends outwards, telescopically from the console 506.

While, FIG. 6b illustrates the manner in which the rigid frame 602 may be opened, FIG. 6c illustrates the rigid frame 602 in completely open condition, i.e., in completely deployed condition. At a distal end, the rigid frame 602 has a locking mechanism (not shown in figures). The locking mechanism locks the rigid frame 602 with the backboard 110 and maintains the rigid frame 602 in position during deployment and operation of the CPR device 102.

A perspective view of the rigid frame 602 can be seen in FIG. 6d. As can be seen from FIG. 6d, the rigid frame 602 includes multiple frame segments 602a, 602b . . . 602n, collectively referred to as frame segments 602-n. The frame segments 602-n are telescopically disposed to form the rigid frame 602. For example, a second frame segment 602b may slide in a groove 604 of a first frame segment 602a; a third frame segment 602c may slide in a groove 606 of the second frame segment 602b; and so forth.

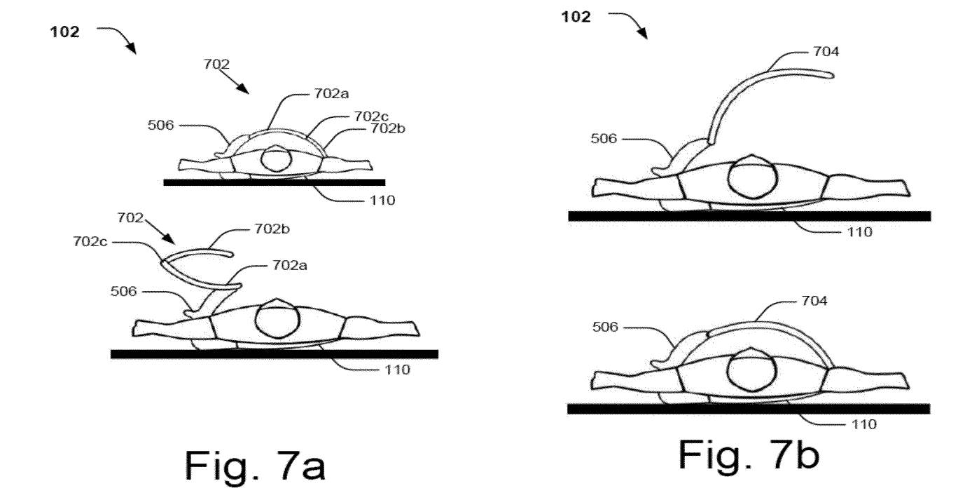

In alternative embodiments, the rigid frame 602 can be a hinged structure, or a collapsible structure, or a single continuous rigid element that can be attached to the console 506 and the backboard 110. Accordingly, FIG. 7a shows a rigid frame 702 having a hinged structure, according to another embodiment of the present subject matter. The rigid frame 702 can be attached to the console 506 and the backboard 110. The rigid frame 702 has a first moving frame 702a and a second moving frame 702b connected with a hinge 702c. A lower portion of FIG. 7a shows the rigid frame 702, in a non-deployed position, hinged at the console 506. An upper portion of FIG. 7a shows the rigid frame 702 in a fully deployed position.

FIG. 7b shows a rigid frame 704 having a single rigid element attached to the console 506 from one end, according to an embodiment of the present subject matter. An upper portion of FIG. 7b shows a non-deployed frame 704 attached at the console 506. A lower portion of FIG. 7b shows a completely deployed frame 704.

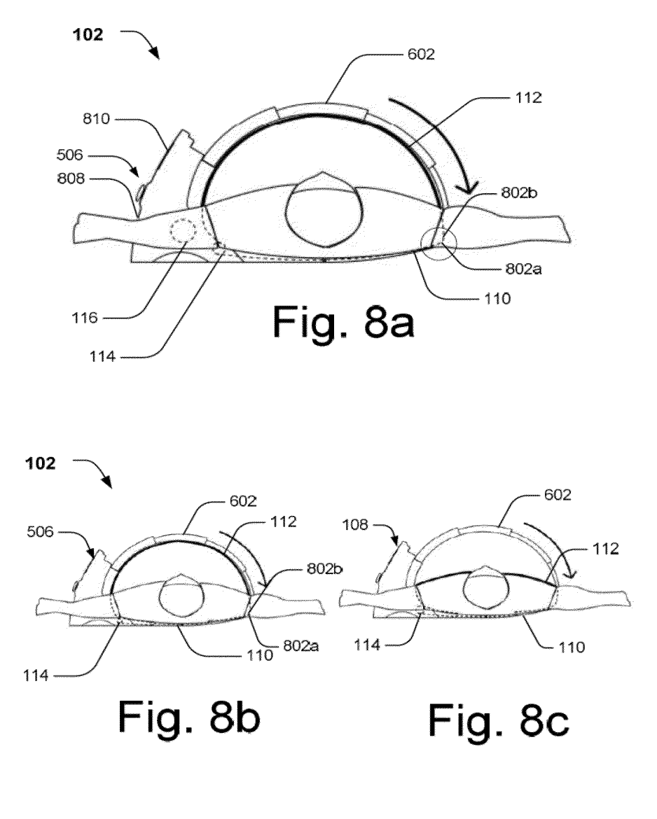

Once the rigid frame 602, 702, 704 is completely deployed, one end of the constriction element 112 is drawn out from one end of the backboard 110 and is adapted to constrict a subject. FIGS. 8a and 8b illustrates the deployment of the constriction element 112 of the CPR device 102. In an example, the constriction element 112 has distal attachments 802a and 802b. The distal attachments 802a and 802b snap to make a loop, as the frame 602 gets locked with the backboard 110, as shown in FIGS. 8a and 8b.

In the represented embodiment, the constriction element 112 is provided in the form of belt mounted on the rollers 114. In alternative embodiments, the constriction element 112 can be at least one of a band-like structure, a strap-like structure, a belt-like structure or a jacket-like structure. The deployment or constriction of the constriction element 112 is achieved either by manual or automated means, such as a power drive or a manual power input, or by just strapping the constriction element 112 around the sternum region on the subject's chest. In an implementation, the constriction element 112 is routed through the backboard 110 and is arranged eccentric to a central axis (not shown in figures) of the CPR device 102.

Further, once the constriction element 112 is completely deployed along the sternum region of a subject as shown in FIG. 8c, the drive mechanism 116 constricts or slackens the constriction element 112 to deliver active compression and decompression cycles of the CPR. In an embodiment, the drive mechanism 116, along with a power source 808 and electronic control units 810, is housed inside the console 506 of the CPR device 102.

Further, in an embodiment, the drive mechanism 116 can be a pneumatic unit, say mounted on the rigid frame 602. The drive mechanism 116 is connected to a compressed air source, such as compressor, compressed air cylinder, etc, which provides compressed air for a CPR operation. The drive mechanism 116 includes a number of pneumatic drive cylinders, each accommodating a piston and a shaft. One end of the shaft is connected to the piston and the other end of the shaft is connected to compression/decompression pneumatic pad. Once the drive mechanism 116 is actuated by the compressed air, the pistons in the pneumatic drive cylinders are displaced from top dead position to bottom dead position to perform compression cycle or vice versa. The drive mechanism 116 may include a control unit that has a microprocessor running on rechargeable batteries.

The control unit may be used to time the alternating flow of the compressed air through valves of the compressed air source, and thereby controlling or varying the rate at which pneumatic pads compress or decompress a subject's chest. In the present embodiment, the control unit may also be configured to selectively deliver and remotely regulate the circumferential and sternum compression and decompression. For example, the control unit in the integrated resuscitation system may selectively deliver the active sternum compression at a point in time selected from one of a beginning and an end of a compression cycle. Similarly, the control may selectively deliver the active sternum decompression at a point in time selected from one of a beginning and an end of a decompression cycle.

In another embodiment, the drive mechanism 116 can be an electric motor, for example, stepper motor, which tightens and loosens the constriction element 112 for performing CPR. Further, the electric motor is coupled with a gear box having clutch and brake arrangement. The electric motor may be present within the console 506. Additionally, in an implementation, the spools or rollers 114 can be directly mounted on the electric motor. In another implementation, an electric motor can be mounted inside each spool 114 for achieving a compact design of the CPR device 102. Further, the spools or rollers 114 can be present below the subject. Further, in one implementation, an output shaft torque and the revolutions of the electric motor of the drive mechanism 116 are monitored using encoders. In said implementation, in case the parameters associated with the output shaft torque and revolution of the electric motor overshoot a predetermined value, the CPR device 102 may be automatically shut down after releasing the constriction element 112 to prevent any damage to the subject.

Further, in an implementation, pulleys can be used for transmitting the power from the power source 808 of the drive mechanism 116 to the spools 114 to constrict the constriction element 112. In one example, two pulleys (not shown) are embedded in the backboard 110 to transmit the power from the drive mechanism 116 and to constrict the constriction element 112 symmetrically. In another embodiment, the two pulleys may be provided on the top of the subject.

Further, the power source 808 may include batteries and inbuilt charging circuit. In an example, the batteries and the charging circuit may be present in the console 506 of the CPR device 102. In another example, the charging circuit may be provided as an external unit. The charging circuit provided as an external unit may be designed in such a way that the CPR device 102 is capable of deriving power from ambulance batteries.

In one embodiment, the CPR device 102 is configured to achieve hot swapping of batteries during the operation of the CPR device 102. By means of hot swapping configuration, the batteries of the CPR device 102 can be replaced without significant interruption to the operation. Hence, an operator can connect and disconnect the batteries without rebooting the system of the CPR device 102 and thus a valuable time is saved.

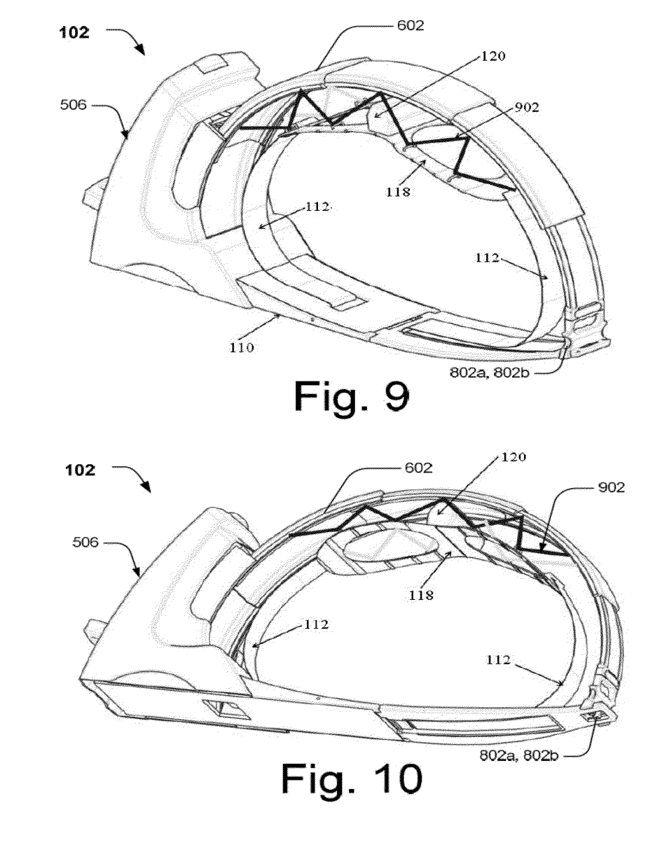

FIGS. 9 and 10 show two different perspective views of the CPR device 102 with the constriction element 112, in accordance an embodiment of the present subject matter. As described previously, in the region of the chest including sternum region, the decompression element 118 becomes a part section of the constriction element 112 for active decompression. Further, the sternum compression unit 120 is attached to the decompression element 118 in the sternum region such that the sternum compression unit 120 is attached on a side of the decompression element 118 facing away from the backboard 110 in one embodiment.

In one embodiment, as shown in FIGS. 9 and 10, the constriction element 112 from the section of the decompression element 118 can be connected with the frame 602 with the help of link elements 902. In the embodiment represented in FIGS. 9 and 10, the link elements 902 are flexible belts. The link elements 902 at one end are connected with the frame 602 and at another end, connected with either, or the constriction element 112 and the decompression element 118, or with both. The link elements 902 can also be woven at multiple points both on the frame 602 and the constriction element 112 or the decompression element 118. On one end, the link elements 902 can be mounted on a spool or roller 114 (not shown in figures) to allow the link elements 902 to get appropriate pretension prior to initiation of the compression cycle. During the compression cycle, the link elements 902 are stretched and thus store energy. During the decompression cycle, the stored energy of the link elements 902 is used to pull the chest circumferentially outward by pulling the constriction element 112 and/or the decompression element 118.

In the embodiment represent in FIGS. 9 and 10, the link elements 902 are flexible belts. In said embodiment, the link elements 902 can be in the form of elastic or flexible belts, springs, rubbers, etc. In an alternative embodiment, the link elements 902 can be formed as rigid components, such as non-stretchable decompression belt. During the compression, the non-stretchable decompression belt is spooled on spools or rollers (not shown), driven by a drive means, to deliver active compression during CPR. Similarly, during the decompression, the reverse spooling of the non-stretchable decompression belt delivers active decompression.

In one alternative implementation, the CPR device 102 may include a constriction element 112 that is provided with inbuilt link elements. Each link element is formed from at least one of flexible belt, spring, and rubber. In an alternative implementation, the link element can be formed from a rigid structure that is pulled by a drive during a compression cycle.

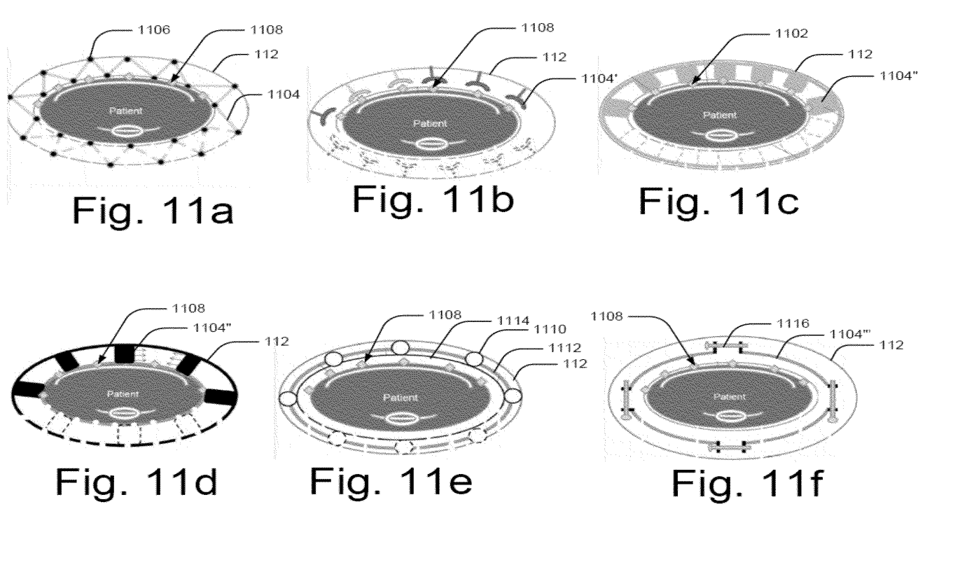

FIGS. 11a to 11f illustrate different variants of link elements 902, in accordance with the present subject matter. In FIG. 11a, the constriction element 112 includes multiple link elements 1104 pivoted with adjacent link elements 1104. The link elements 1104 can be loaded with springs 1106. Further, during operation, the link elements 1104 can be activated by constricting the constriction element 112. The activation of link elements 1104 leads to compression of the circumference of the constriction element 112, which in turn leads to contraction of the chest. The link elements 1104 at the sternum region can be actuated to a greater extent so that they have higher inward travel as compared to remaining link elements 1104. With the de-activation of the link elements 1104, the link elements 1104 return to their original expanded position due to the elasticity of the springs 1106. The constriction element 112 may be provided with either adhesives or vacuum cups 1108 inbuilt on inner surface. The adhesives or vacuum cups 1108 pull the chest wall actively outward during the expansion of the constriction element 112.

In FIG. 11b, the constriction element 112 is mounted with multiple pedals 1104′. The pedals 1104′ can be activated either by electrical, pneumatic or hydraulic means. An end of the pedal 1104′ facing a subject has adhesives or vacuum cups 1108. In the variant represented in FIG. 11b, the individual pedals 1104′ can be activated independently and can have variable compression depths.

In FIG. 11c, the constriction element 112 includes multiple chambers 1104″ embedded inside an outer periphery of the constriction element 112. The chambers 1104″ can be expanded with the air/fluid under pressure. An external end of the chamber 1104″ forms either a vacuum joint or adhesive joint 1102. When the air/fluid is forced inside the chambers 1104″, the chambers 1104″ expand. This leads to exertion of circumferential force. Valves connected to the individual chambers 1104″ can be activated independently and hence variable volume can be injected into the chambers 1104″. In FIG. 11d, the chambers 1104″ are rigid, non-expandable, chambers. The rigid chambers 1104″ move towards each other when the constriction element 112 is constricted, and thus provide the required elasticity.

In FIG. 11e, multiple pulleys 1110 are mounted on flexible links 1112. Further, a string 1114 is wound around the pulleys 1110 and one free end of the string 1114 is fixed, say to a frame of the constriction element 112. Further, during operation, the other free end of the string 1114 is pulled and the circumference of the constriction element 112 is constricted because of the movement of the pulleys 1110 circumferentially inwards, towards a central longitudinal axis of the CPR device 102 or of the subject. The inward movement of the pulleys 1110 causes the flexible links 1112 to constrict. The flexible links 1112 are integrated within the constriction element 112 in this variant. Further, inner surface of the constriction element 112 have either adhesives or vacuum cups 1108.

In FIG. 11f, the constriction element 112 includes multiple rigid links 1104′″ with gap in-between. One or more screws 1116 are provided to join adjacent rigid links 704′″. The constriction element 112 is operated by rotating the screws 1116. With the rotation of the screw 1116, the gap between adjacent links 1104′″ is reduced, leading to circumferential compression of a subject's chest.

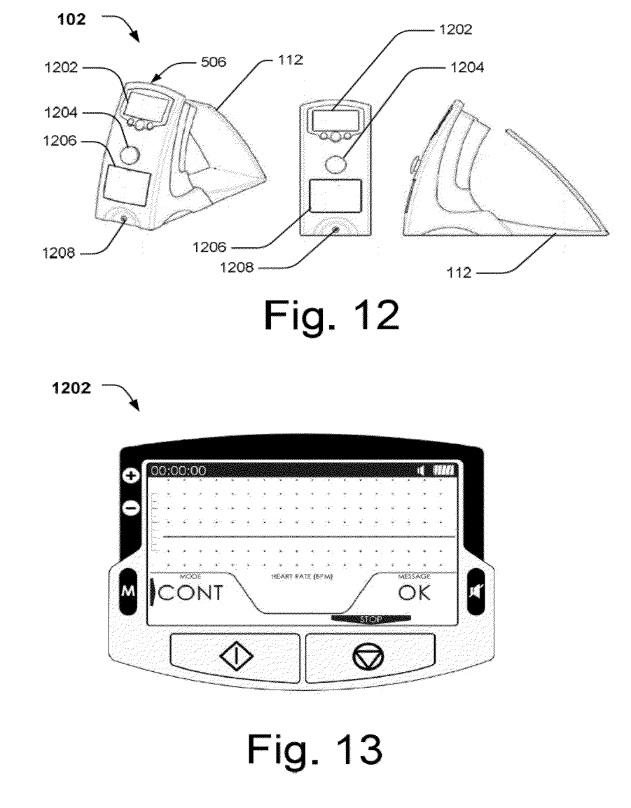

FIG. 12 shows different perspective views of the CPR device 102 in non-deployed condition, in accordance with an embodiment of the present subject matter. The console 506 of the CPR device 102 includes, for example, an input-and-display unit 1202. The input-and-display unit 1202 displays values of parameters, such as vital signs, say ECG, heart rate, and other physiological parameters, and information relating to frequency of compression/decompression cycles, depth of compression cycle. The input-and-display unit 1202 can help in monitoring such parameters, as described above. The console 506 further includes an emergency button 1204 to stop the drive mechanism 116, such as a stepper motor, for instance upon detection of excessive force on subject or during any malfunction in the CPR device 102. The console 506 further includes a receiving chamber 1206 for the power source 808 to power the CPR device 102. The console 506 also includes a charging point 1208 for charging the power source 808.

By means of the input-and-display unit 1202, a front-end software and user interface can discretely select parameters, such as depth of compression. The depth of compression is determined by length of the belt around the thorax of the subject. In an example, an electronic circuit with microcontroller controls the drive mechanism 116. In said example, the microcontroller receives commands from the front-end software through a peripheral component interconnect (PCI) bus based card. The microcontroller in turn controls the speed of rotation, direction of rotation and number of steps of the drive mechanism 116, for example, stepper motor. With this, the controlled and precise functioning of the CPR device 102 may be achieved.

Additionally, the input-and-display unit 1202 may function as a real time feedback unit. In one embodiment, the input-and-display unit 1202 can be integrated within the CPR device 102 or, in another embodiment; a separate input-and-display unit 1202 can be connected to the CPR device 102 via a wired or wireless system. The input-and-display unit 1202 has a display and can provide audio alarm/command prompts. The input-and-display unit 1202 includes an in-built logic that checks various checkpoints, such as frame latching and constriction element latching. If the in-built logic finds any fault associated with the CPR device 102, the input-and-display unit 1202 prompts an operator about the fault by means of at least one of an audio and visible formats. Further, in an example, unless the fault is corrected, the CPR device 102 may not start its functioning. The inbuilt logic also checks whether electrodes are appropriately positioned on a human body and whether vital signs are present or absent. However, the CPR device 102 is configured in such a way that the operator is allowed to overdrive fault conditions associated with vital signs.

In one embodiment, multiple languages can be set in the CPR device 102 to take care of various vernaculars. Further, the operator may operate the CPR device 102 in various modes. In an example, in a normal operating condition, the input-and-display unit 1202 displays the ECG, compression rate, heart rate, compression mode—continuous or allowable ventilation breaths in between, battery charge, etc. The input-and-display unit 1202 is shown in detail in FIG. 13.

As mentioned earlier, the backboard 110 may be integrated with electrodes (not shown in figures). In said implementation, the electrodes may be integrated with the input-and-display unit 1202 and may facilitate in monitoring the vital parameters, such as electrocardiogram (ECG), heart rate, compression rate, compression depth, etc. Further, as mentioned earlier, the electrodes may be used for defibrillation to the subject.

In one embodiment, the subject matter describes a method of performing CPR by means of the CPR device 102. The order in which the method is described is not intended to be construed as a limitation, and individual steps may be deleted from the method without departing from the spirit and scope of the subject matter described herein. Furthermore, the method can be implemented in any suitable hardware, software, firmware, or combination thereof. The method is presently provided for selection based purchasing and purchasing a product at a local vendor.

In one embodiment, whenever a subject suffers SCA, a CPR team or a CPR operator is alerted. The CPR operator retrieves the CPR device 102 from its place of storage. Then, the CPR operator may telescopically deploy the CPR device 102, for example, in a manner shown in FIGS. 5a to 6d. The operating system of CPR device 102 detects the deployment of the backboard 110 and begins auto boot to save time. Once the CPR device 102 is deployed completely as shown in FIG. 8c, the operating system may wait for user prompt to continue. For example, the operator may press OK button on the input-and-display unit 1202 to continue. Then, by means of the drive mechanism 116, the CPR device 102 tightens the constriction element 112 to a predefined tension.

The operating system determines subject body type based on extent of utilization of the constriction element 112. Based on the subject body type, the operating system, via the input-and-display unit 1202, displays operating parameters, such as body type, stroke rate (can be set at a default value of 102 bpm), OK status, and other parameters, such as stroke ratio, sternum depth, etc. In case the operating parameters are not correct, the CPR operator may manually adjust the operating parameters using navigation keys of the input-and-display unit 1202. Once the operating parameters are verified by the CPR operator, the CPR operator presses a START button provided on the input-and-display unit 1202 to start the CPR process. The CPR device 102 then delivers active chest compression to a subject by constricting a constriction element 112 of the CPR device 102, where the constriction element 112 includes a decompression element 118 as a part on a circumference of the thoracic region of a subject Then, the active sternum compression is delivered with the sternum compression unit 120 attached to the decompression element 118 and adapted to compress to the subject. The active sternum compression is followed by the active sternum decompression delivered with a decompression of the sternum compression unit 120 and slackening of the constriction element 112. Finally, the active chest decompression is delivered with slackening of the constriction element 112 to pull back the decompression element 118.

Thus, the CPR device 102 may perform cycles of active sternum compression, active circumferential compression, active sternum decompression and active circumferential decompression. It will be understood that various cycles may be performed sequentially or simultaneously.

In one example, first, active circumferential compression may be delivered to the subject, followed by a combination of active circumferential and active sternum compressions. Similarly, first active sternum decompression is performed, followed by circumferential and sternum decompressions. Alternatively, the circumferential and sternum compression and decompression may be selectively delivered to the subject and regulated remotely.

In another example, the active circumferential and sternum compression delivered may be manipulated and varied in different cycles to suit the subject. For example, a combination of an initial cycle of circumferential compression for a certain period followed by sternum compression, which may be followed by circumferential decompression and sternum decompression, may be provided. Similarly, the cycles may be varied to include only sternum compression and sternum decompression. During subsequent sternum compressions, the cardiac output may be enhanced due to increased venous return and myocardial perfusion. The CPR device 102 described herein may maximize the physiologic behavior to increase perfusion as compared to other available devices.

In an embodiment, the method for performing CPR includes the telescopic deployment of the CPR device 102. In the telescopic deployment, initially, the backboard 110 is opened. The backboard includes multiple-segments, where the multiple segments are telescopically extendable from one another to deploy the backboard 110. Once the backboard 110 is completely deployed, an operating system automatically reboots the CPR device 102 by the actuation switch 502 integrated within the backboard. The completely deployed backboard 110 is placed below a subject to support the subject in a supine position. Then, frame segments 602a, 602b, 602c are telescopically deployed to form a frame 602, where one end of the frame 204 is connected to the console 506 and another end of the frame 602 is locked at an end of the backboard 110 distant from the console 506. Thereafter, the subject is constricted by laterally extending the constriction element 112, where the constriction element 112 is connected to the frame 506 and is extended at least partially around the subject to constrict the subject.

In one embodiment, the operating system may monitor pressure and/or force parameters from sternum compressions and circumferential compressions, during the CPR process. The operating system may check whether the pressure parameters are correct or not. In case the pressure parameters are not correct, the input-and-display unit 1202 may raise an alarm regarding the fault condition. In case the pressure parameters are correct, the CPR device 102 continues to provide CPR. In one embodiment, the CPR operator may also monitor the progress from time to time on the display of the input-and-display unit 1202.

In an embodiment, in case the operator is prompted with alarm or the subject is revived from the SCA, the CPR operator provides the abort instruction to the CPR device 102. The inbuilt logic of the CPR device 102 checks whether the abort instructions are received or not. In case no abort instructions are received, the inbuilt logic continues the CPR process and continues to check for abort instructions. In case the abort instructions are received, the inbuilt logic stops the compressions.

In one embodiment, the operating system displays by means of the input-and-display unit 1202 all the selected operating parameters and run time entries. The CPR operator may take a note of the data log of the subject or store the log in the built memory available in the CPR device 102.

In one embodiment, the CPR device 102 may be provided with safety mechanisms. For the CPR device 102 to work safely without harming the subject, the operator or the surrounding people, a number of safety mechanisms are included in the CPR device 102. First safety mechanism is to ensure that torque a motor shaft does not exceed a predetermined limit of torque. Encoders are provided at a motor shaft of the electric motor to measure the torque at the motor shaft. If the torque at the motor shaft exceeds a predetermined level, the system shuts down after releasing the constriction element 112. Second safety mechanism is to check the displacement of the constriction element 112. In case the displacement of the constriction element 112 exceeds a predetermined constriction suitable for the subject size, the system may shut down after releasing the constriction element 112. Third safety mechanism is to automatically break a link provided to the constriction element 112 when the load exceeds a predetermined load value. Fourth safety mechanism is to loosen web of the constriction element 112 without tearing the constriction element 112, if the compression/decompression force exceeds a predetermined value. Fifth safety mechanism is to loosen the constriction element 112 and to shut down the CPR device 102, when the current and voltage values exceed a predetermined limit.

The effectiveness and consistency of operation of the CPR device 102 may be achieved through automation of drive mechanism and microcontroller based electronic circuit.

The present subject matter provides a CPR device for sudden cardiac arrest subjects. In one electromechanical embodiment, the CPR device includes two-piece sliding backboard, belt-like structure as the constriction element, springs as the link elements, an electric motor as drive mechanism, a battery as the power source, and adhesive or pneumatic pads as the decompression pad.

In another electromechanical embodiment, the CPR device includes two-piece sliding backboard, belt-like structure as the constriction element, a rigid frame for supporting the belt-like structure, spring as the link elements, an electric motor as the drive mechanism, a battery as the power source, and adhesive or pneumatic pads as the decompression pad.

In yet another electromechanical embodiment, the CPR device 102 includes two-piece sliding backboard, belt-like structure as the constriction element, a rigid frame for supporting the belt-like structure, elastic belt as the link elements, an electric motor as the drive mechanism, a battery as the power source, and adhesive or pneumatic pads as the decompression pad.

In a further pneumatic embodiment, the CPR device 102 includes two-piece sliding backboard, belt-like structure as the constriction element, cylinder displacement of pneumatic cylinders as the link elements, pneumatic cylinders as the drive mechanism, a compressor or compressed air cylinder as the power source, and adhesive or pneumatic pads as the decompression pad.

The CPR device 102 of the present subject matter can be deployed at various places, such as in government hospitals, private hospitals and emergency ambulance services.

### Test and Validation

In respect to the present subject matter, a representative model of human chest cavity is designed to simulate human blood flow circulation and dynamics of compression, during CPR to test the effectiveness of active sternum and circumferential compression and active sternum and circumferential decompression. The said representative model includes simulated blood circulation unit. The simulated blood circulation unit includes a right-side chamber representing right atrium and right ventricle. The right-side chamber is connected to a non-return valve to prevent reverse flow at its entry. Similarly, left atrium and left ventricle are represented with a left-side chamber. The left-side chamber is also connected to a non-return valve to prevent reverse flow at its entry.

Further, as human lungs are positioned on either side of a heart, the simulated blood circulation unit further includes a simulated lung unit containing two cylindrical chambers representing pulmonary vasculature in lungs. The simulated lung unit is connected to the right-side chamber, through a not return valve, representing pulmonary valve. Similarly, the output of the simulated lung unit passes through a non-return valve to prevent reversal of flow and is connected to the left-side chamber. Further, a simulated ribcage is built using polymer rib cage elements pivoted to the back using spherical joints to approximate rib cage motion.

For the test, the simulated blood circulation unit is inserted inside the simulated rib cage and is then enclosed in an oil filled chamber, which simulates a real body dynamics in which adjacent organs exert force on each other during compression. In the oil filled chamber, a small amount of air is left inside to compensate for compressibility of the simulated lung unit.

A number of methods for performing compression and decompression cycle during CPR are performed on the representative model of human chest cavity for testing as described below.

### Example 1

In an example, a pure sternum compression is performed either manually or remotely by manual or electronic means. Depth of at least 35 mm at the sternum of a subject is achieved by the CPR device described in the present subject matter. By performing 15 strokes of the sternum compression, a volumetric blood flow at delivery side of the about 2.86667 ml (volume/stroke) is achieved from a volumetric blood flow at suction side of about 2.26667 ml (volume/stroke). Thus, an output volume of approximately 2.86667 ml (volume/stroke) is achieved. The pure sternum compression is a normal method of delivering CPR and thus gives a base data to compare with the data of other methods of delivering CPR.

### Example 2

In another example, a pure circumferential compression is performed either manually or remotely by manual or electronic means. Depth of at least 35 mm at the sternum of a subject is achieved by the CPR device described in the present subject matter. By performing 15 strokes of the pure circumferential compression, a volumetric blood flow at delivery side of about 5.13333 ml (volume/stroke) is achieved from a volumetric blood flow at suction side of about 3.13333 ml (volume/stroke). The pure circumferential compression is delivered by the CPR device described in the present subject matter to verify if the circumferential pressure is more useful in improving perfusion volume.

The circumferential compression involves the pulmonary vasculature (thoracic pump mechanism) and as a result leads to improved flow rate. Thus, the volumetric blood flow at delivery side of the circumferential compression is improved by 79% as compared to the sternum compression. Although the volumetric blood flow at delivery side increases, a pressure of blood at the delivery side is lower in the circumferential compression than sternum compression, as the circumferential compression does not act directly on the heart in manner like the sternum compression.

### Example 3

In yet another example, a circumferential compression in combination with a sternum compression is performed either manually or remotely by manual or electronic means. Depth of at least 35 mm at the sternum of a subject is achieved by the CPR device described in the present subject matter. By performing 15 strokes of the circumferential compression in combination with the sternum compression, a volumetric blood flow at delivery side of about 5.8 ml (volume/stroke) is achieved from a volumetric blood flow at suction side of about 2.8 ml (volume/stroke). The circumferential compression in combination with the sternum compression is intended to identify whether a sudden thrust at the sternum after constricting the chest through circumferential compression give better yield.

There is an improvement of about 13% in flow rate with respect to the pure circumferential compression. Also, in the present example, the sternum compression is delivered once the circumferential compression is completely delivered, which in turn increases a pressure of blood at the delivery side as high as it is performed with a pure sternum compression. Thus, the combination of the sternum compression and the circumferential compression leads to both better volumetric and pressure values.

### Example 4

In yet another example, a sternum compression in combination with a sternum decompression is performed either manually or remotely by manual or electronic means. Depth of at least 35 mm at the sternum of a subject is achieved by the CPR device described in the present subject matter. By performing 15 strokes of the sternum compression in combination with the sternum decompression, a volumetric blood flow at delivery side of about 3.4 ml (volume/stroke) is achieved from a volumetric blood flow at suction side of about 2.86667 ml (volume/stroke). The sternum compression in combination with the sternum decompression is intended to establish whether supplementing recoil causes more volumetric flow in next stroke of compression. In the present example, the decompression is limited to sternum so that differentiation between the sternum decompression and a circumferential decompression can be established.

By the combination of the sternum compression and the sternum decompression, there is about 18.6% improvement in volumetric blood flow at the delivery side in comparison to the pure sternum compression. Moreover, a pressure of blood at the suction side improves by about 14%. This means return of blood would be better as pressure differential is better.

### Example 5

In yet another example, a circumferential compression in combination with a circumferential decompression is performed either manually or remotely by manual or electronic means. By performing 15 strokes of the circumferential compression in combination with the circumferential decompression, a volumetric blood flow at delivery side of about 6.73333 ml (volume/stroke) is achieved from a volumetric blood flow at suction side of about 4.8 ml (volume/stroke). The circumferential compression in combination with the circumferential decompression intends to establish gains via circumferential decompression in improving CPR efficiency.

By the combination of the circumferential compression with the circumferential decompression, there is about 31% increase in the volumetric blood flow at the delivery side in comparison to the pure circumferential compression with a very good pressure of blood at the delivery side. Thus, the circumferential decompression results in an increase in the volumetric flow of the blood at the delivery side.

Based on the volumetric efficiencies of the above-mentioned five examples, the circumferential compression along with the circumferential decompression is shown to have maximum volumetric efficiency. The circumferential compression along with sternum compression shows lower volumetric efficiency than circumferential compression along with the circumferential decompression. Pure circumferential compression and the sternum compression along with sternum decompression are next best to the above three methods in terms of volumetric efficiency, while pure sternum compression is the least effective.

Further, as can be gather from above mentioned examples, the sternum compression along with circumferential compression improves delivery pressure and volume. Thus, the results clearly indicate process improvement in terms of volumetric efficiency and delivery pressure based on principle of similar flow and body dynamics, when active circumferential and sternum decompression are used in addition to active compression.

Although implementations of a CPR device and an integrated resuscitation system have been described in language specific to structural features and/or methods, it is to be understood that the subject matter is not necessarily limited to the specific features described. Rather, the specific features and methods are disclosed as implementations for the CPR device and the integrated resuscitation system including the CPR device.

1-26. (canceled)

27. A cardio pulmonary resuscitation (CPR) device comprising:
a backboard to support a subject in a supine position;
a constriction element operationally coupled to the backboard, wherein the constriction element is capable of being placed across a thoracic region of the subject to constrict the subject;
a decompression element connected to the constriction element such that the decompression element becomes a part of the constriction element and faces the backboard, wherein the decompression element is disposed substantially along the circumference of a thoracic region of the subject on deployment, further wherein the decompression element is adapted to adhere to the subject on deployment; and
a sternum compression unit operationally coupled to the constriction element such that the sternum compression unit is disposed in a sternum region on deployment, wherein the sternum compression unit is adapted to compress the sternum of the subject to deliver active sternum compression and to be pulled back to deliver active sternum decompression,
wherein the constriction element is adapted to be constricted for delivering active circumferential compression and compressing the decompression element, such that the decompression element adheres to the subject while delivering active circumferential compression, and
wherein the constriction element is adapted to be slackened for pulling back the decompression element that is adhered to the subject to deliver active circumferential decompression.

28. The CPR device as claimed in claim 27, wherein the backboard is a multi-segment structure comprising an actuation switch integrated with the backboard, and wherein the actuation switch is configured to automatically reboot an operating system of the CPR device upon deployment of the backboard.

29. The CPR device as claimed in claim 27, wherein the decompression element is disposed on the constriction element such that the decompression element faces the backboard, and wherein the sternum compression unit is disposed through the constriction element to be placed in the sternum region of the subject.

30. The CPR device as claimed in claim 27, wherein the constriction element is a single continuous structure comprising a plurality of decompression elements disposed on the constriction element such that the plurality of decompression elements face the backboard, and wherein the sternum compression unit is disposed through the constriction element in the sternum region of the subject.

31. The CPR device as claimed in claim 27, wherein the decompression element comprises at least one of a vacuum cup, a pneumatic pad, a micropore with vacuum, and an adhesive patch for adhering to the subject.

32. The CPR device as claimed in claim 27, further comprising a console operationally coupled to the constriction element, wherein the console comprises:
a power source;
a drive mechanism electrically connected to the power source; and
at least one spool operably connected to the drive mechanism to spool the constriction element during constriction and slackening.

33. The CPR device as claimed in claim 32, wherein the console further comprises a control unit for controlling the rate of compression and decompression to selectively deliver the active sternum compression, the active circumferential compression, the active sternum decompression, and the active circumferential decompression.

34. The CPR device as claimed in claim 32, wherein the console further comprises a frame adapted to unfold and extend out from the console on deployment.

35. The CPR device as claimed in claim 34, further comprising link elements connected at one end with the frame and connected at another end with at least one of the decompression element and the constriction element.

36. The CPR device as claimed in claim 35, wherein the link elements are formed from at least one of flexible belt, spring, and rubber.

37. The CPR device as claimed in claim 35, wherein the link elements are formed from a rigid decompression belt.

38. The CPR device as claimed in claim 35, further comprising one or more safety mechanisms to ensure safe operation of the CPR device.

39. An integrated resuscitation system comprising:
a CPR device, the CPR device comprising:
a constriction element capable of being operationally coupled to a backboard, wherein the constriction element is capable of being placed across a thoracic region of the subject to constrict the subject;
a decompression element connected to the constriction element such that the decompression element becomes a part of the constriction element and faces the backboard, wherein the decompression element is disposed along the circumference of a thoracic region of the subject on deployment, further wherein the decompression element is adapted to adhere to the subject on deployment and
a sternum compression unit operationally coupled to the constriction element such that the sternum compression unit is disposed in a sternum region of the constriction element on deployment, wherein the sternum compression unit is adapted to compress a sternum of the subject to deliver active sternum compression and to be pulled back to deliver active sternum decompression,
wherein the constriction element is adapted to be constricted for delivering active circumferential compression, for compressing the decompression element, such that the decompression element adheres to the subject to deliver active circumferential compression, and
wherein the constriction element is adapted to be slackened for pulling back the decompression element to deliver active circumferential decompression;
a console operationally coupled to the constriction element, the console being configured to control deployment of the CPR device; and
a real-time monitoring-and-feedback unit coupled to the CPR device, wherein the real-time monitoring-and-feedback unit comprises:
electrodes attached to at least one of the backboard and the constriction element for monitoring medical parameters of the subject; and
an output unit to provide the medical parameters as an output.

40. The integrated resuscitation system as claimed in claim 39, wherein the real-time monitoring-and-feedback unit further comprises electronic transceivers for communicating the medical parameters to a central control unit.

41. The integrated resuscitation system as claimed in claim 39, wherein the electrodes are adapted to monitor at least one of an electrocardiogram (ECG), heart rate, compression rate and compression depth, during delivery of CPR.

42. The integrated resuscitation system as claimed in claim 39, further comprising a defibrillator unit connected to the CPR device, wherein the defibrillator unit comprises defibrillating pad disposed on at least one of the backboard, decompression element, and the constriction element.

43. The integrated resuscitation system as claimed in claim 39, wherein the backboard comprises an actuation switch integrated with the backboard, and wherein the actuation switch is configured to automatically reboot an operating system of the CPR device upon deployment of the backboard.

44. The integrated resuscitation system as claimed in claim 39, wherein the console further comprises a control unit for controlling the rate of compression and decompression to selectively deliver the active sternum compression at a point in time selected from one of beginning and end of a compression cycle.

45. The integrated resuscitation system as claimed in claim 39, wherein the console further comprises a control unit for controlling the rate of compression and decompression to selectively deliver the active sternum decompression at a point in time selected from one of beginning and end of a decompression cycle.

46. A method for performing cardio pulmonary resuscitation by an integrated resuscitation system, comprising:
deploying a CPR device;
delivering active circumferential compression to a subject by constricting a constriction element of the CPR device, wherein the constriction element is a multi-segment structure comprising a decompression element along the circumference of thoracic region of the subject;
delivering active sternum compression with a sternum compression unit, operationally coupled to the constriction element, in a sternum region of the subject and adapted to compress the sternum region of the subject;
delivering active sternum decompression with a decompression of the sternum compression unit and slackening of the constriction element; and
delivering active chest decompression with slackening of the constriction element to pull back the decompression element at least partially along a circumference of thoracic region of the subject.
